(19) United States
(12) Patent Application Publication
(10) Pub. No.: US 2021/0030086 A1
(43) Pub. Date: Feb. 4, 2021

(54) METHOD OF MANUFACTURING A TEXTURED FORMER AND A GLOVE MADE THEREFROM

(71) Applicant: TOP GLOVE INTERNATIONAL SDN. BHD., Klang (MY)

(72) Inventors: CHONG BAN WONG, KLANG (MY); AI TING TAN, KLANG (MY); ZU XIAN TEO, KLANG (MY)

(21) Appl. No.: 16/930,313

(22) Filed: Jul. 15, 2020

(30) Foreign Application Priority Data
Jul. 29, 2019 (MY) PI2019004342

(51) Int. Cl. A41D 19/00; A41D 19/04; B33Y 10/00; B33Y 50/02; B29C 33/42; B33Y 80/00; B29C 33/76; B29C 33/38; B28B 1/26; B29C 41/14

(52) U.S. Cl. CPC A41D 19/0082; A41D 19/04; A41D 19/0062; B33Y 10/00; B33Y 50/02; B29C 33/424; B29L 2031/4864; B29C 33/76; B29C 33/3814; B28B 1/26; B29C 41/14; A41D 2400/80; B33Y 80/00

(57) ABSTRACT

A method of manufacturing a textured former and a glove made therefrom, wherein the method comprises preparing a hand-shaped ceramic greenware, scanning the hand-shaped ceramic greenware to generate a digital 3D hand-shaped greenware model, modelling a pair of stencil covers with curvy texture line based on the digital 3D hand-shaped greenware model, printing the stencil covers, creating a curvy palm texture on the hand-shaped ceramic greenware with the aid of the stencil covers, firing the hand-shaped ceramic greenware with curvy palm texture in a kiln and dipping the hand-shaped ceramic former with curvy palm texture in an aqueous colloidal dispersion to produce glove with curvy palm texture.

### CROSS REFERENCE TO RELATED APPLICATION

This application which claims priority to Malaysia Patent Application No. P12019004342 filed on 29 Jul. 2019.

### FIELD OF THE INVENTION

The present invention relates to a method of making a former and a glove with selected textured surface area.

### BACKGROUND OF THE INVENTION

Gloves continuously assist us in our daily lives especially for those in the field of healthcare, medical, engineering and other technical fields. Gloves should be selected based on their functionality, protection and health needs, comfort and fit, and other important aspects.

Palm texture is an example of a common functional feature that improves gripping ability by covering the fingertips area up to the wrist with a textured surface. The texture can be in an irregular and/or regular shape and the texture line at the wrist is commonly a straight line. The texture is created on a hand-shaped ceramic greenware using sandblasting and/or any ceramic slip deposition procedure such as but not limited to spraying and dipping.

Examination gloves are commonly equipped with palm texture feature to enhance the grip performance during medical procedures. However, the requirement on grip performance of an examination glove is lower than an industrial glove. The coverage of textured area from all five fingertips until wrist is excessive since not all of the hand areas are involved in gripping. The excessive textured area on the examination glove may also create stress concentration point upon stretching and thus deteriorate the mechanical properties of the examination glove. The excessive texture reduces cost effectiveness as it promotes unnecessary latex pick up during glove dipping process.

Hence, it would be highly advantageous to develop an efficient textured glove and a method of producing it.

### SUMMARY OF THE INVENTION

The present invention discloses a method of manufacturing a textured former and a glove made therefrom, wherein the method comprises preparing a hand-shaped ceramic greenware, scanning the hand-shaped ceramic greenware to generate a digital 3D hand-shaped greenware model, modelling a pair of stencil covers with curvy texture line based on the digital 3D hand-shaped greenware model, printing the stencil covers, creating a curvy palm texture on the hand-shaped ceramic greenware with the aid of the printed stencil covers, firing the hand-shaped ceramic greenware with curvy palm texture in a kiln and dipping the hand-shaped ceramic former with curvy palm texture in an aqueous colloidal dispersion to produce glove with curvy palm texture.

### BRIEF DESCRIPTION OF THE ACCOMPANYING DRAWINGS

The present invention will be fully understood from the detailed description given herein below and the accompanying drawings which are given by way of illustration only, and thus are not limitative of the present invention, wherein:

In the appended drawings:

FIG. 1 is an illustrative figure of a front view of a glove with curvy palm texture.

FIG. 2 is an illustrative figure of a rear view of a glove with curvy palm texture.

FIG. 3 is an illustrative figure of a side view of a glove with curvy palm texture (from thumb finger).

FIG. 4 is an illustrative figure of a top view of a glove with curvy palm texture.

FIG. 5 is an illustrative figure of a bottom view of a glove with curvy palm texture.

FIG. 6 is an illustrative figure of a right half cover and a left half cover of a pair of stencil covers.

FIG. 7 is an illustrative figure of an assembly of a hand-shaped ceramic greenware to a pair of stencil covers.

### DETAILED DESCRIPTION OF THE INVENTION

Detailed description of preferred embodiments of the present invention is disclosed herein. It should be understood, however, that the embodiments are merely exemplary of the present invention, which may be embodied in various forms. Therefore, the details disclosed herein are not to be interpreted as limiting, but merely as the basis for the claims and for teaching one skilled in the art of the invention. The numerical data or ranges used in the specification are not to be construed as limiting. The following detailed description of the preferred embodiments will now be described in accordance with the attached drawings.

The present invention relates to a textured former and a method of manufacturing it, in particular a textured former wherein it is used to produce glove that is sufficiently textured at selected areas to provide gripping capability and is not excessively textured to the point where it might create stress concentration point upon stretching and further deteriorating the mechanical properties of the glove.

The present invention shows that the palm textured glove is created by dipping hand-shaped ceramic former with curvy texture line into an aqueous colloidal dispersion instead of externally creating a texture surface layer on a glove. This approach simplifies the textured glove fabrication process as it employs a former with curvy texture only rather than using a standard former and then depositing enhancing particle/liquid on the glove, followed by curing to create a textured glove surface.

Industrial grade gloves and examination/medical grade gloves serve different purposes and suit different conditions. Industrial gloves are designed to withstand specific demands of car mechanics, factory works, caustic chemicals and other hazardous conditions. The design of industrial gloves is made to provide adequate protection against tool slippage and withstand exposure of corrosion longer than most of the examination gloves. As for examination gloves, they are not required to withstand hazardous conditions like industrial gloves as their main functions are to prevent contamination between users and patients as well as to provide sufficient grip to the users when handling medical equipment.

As the requirement of the grip performance for examination gloves is lower than industrial gloves, the present invention focuses on texturing only vital/sufficient areas such as but not limited to the upper palm area. Complete coverage of textured area from the fingertips to the wrist is excessive since not all of the hand areas are directly involved in gripping. Excessive textured areas create stress concentration points when stretching wherein the stress concentration points will eventually deteriorate the mechanical properties of the glove and cause material defects such as but not limited to wear and tear.

By efficiently texturing the glove at selected areas, the durability and lifespan of the glove can be preserved much longer. Moreover, the material and cost effectiveness increase as less material is wasted during the hand-shaped ceramic former manufacturing process and glove dipping process.

The textured hand-shaped ceramic former and glove are prepared by the following methods:
a) Preparing a hand-shaped ceramic greenware by slip casting, followed by drying and sponging after demoulding from slip casting. Alternatively, other type of casting methods may be used.
b) Scanning the hand-shaped ceramic greenware thoroughly using any 3D techniques such as but not limited to short range 3D scanning, medium and long range 3D scanning, laser based 3D scanning and projected or structured light 3D scanning. A digital 3D hand-shaped greenware model is generated and saved.
c) Importing the digital 3D hand-shaped greenware model into any 3D modelling software such as but not limited to Solid Edge, SolidWorks, Creo, Autodesk and Geomagic wherein the digital 3D hand-shaped greenware model serves as a reference during the 3D modelling of a pair of stencil covers for the hand-shaped ceramic greenware.
d) Modelling the stencil covers using the 3D modelling software wherein the modelling techniques involve modelling such as but not limited to surface modelling, freeform modelling and solid modelling. The stencil covers are modelled into two parts, a left half cover and a right half cover wherein they can be assembled and disassembled. When the left half cover is assembled to the right half cover, there is a cavity in between the assembly which allows the digital 3D hand-shaped greenware model to fit in between the covers. The stencil covers comprise a curvy texture line in between the palm and the wrist area wherein the curvy texture line can be in a form of smooth line, step line, irregular line, geometrical line or a combination of at least two types of line as mentioned.
e) Printing the stencil covers using one or more 3D printable materials such as but not limited to thermoplastics, resins, elastomers, metals and metal alloys, ceramics and composites. The stencil covers can be printed using a single 3D printable material or a combination of at least two 3D printable materials.
f) Placing the 3D printed stencil covers in a sandblasting chamber by fixing the left half cover or the right half cover to a fixture on a turntable of the sandblasting chamber. A hand-shaped ceramic greenware is fitted onto the fixed half cover on the turntable. The unfixed half cover is then fitted onto the opposite side of the hand-shaped ceramic greenware to fully cover the hand-shaped ceramic greenware prior to sandblasting procedure. Alternatively, other masking methods and materials may be used to cover the hand-shaped ceramic greenware.
g) Sandblasting the hand-shaped ceramic greenware that is covered by 3D printed stencil covers in the sandblasting chamber using ceramic beads to create curvy palm texture on the hand-shaped ceramic greenware. The size of the ceramic beads ranges from 0.2-1.5 mm in diameter and the sandblasting pressure ranges from 0.1-0.5 bars.
h) Alternatively, ceramic slip is deposited on the hand-shaped ceramic greenware to create curvy palm texture. Similarly, the hand-shaped ceramic greenware is first placed at the designated cavity in between the left half cover and the right half cover of the 3D printed stencil covers. A ceramic slip is prepared by mixing 10-50% clay, 10-50% binder and 10-50% filler with water and then deposited on the hand-shaped ceramic greenware using any ceramic slip deposition procedure such as but not limited to spraying and dipping.
i) Firing the hand-shaped ceramic greenware with curvy palm texture in a kiln at a temperature ranging from 1000° C. to 1500° C. and up to 12 hours.
j) Dipping the hand-shaped ceramic former with curvy palm texture in materials such as but not limited to natural rubber latex and synthetic latex to produce glove with curvy palm texture.

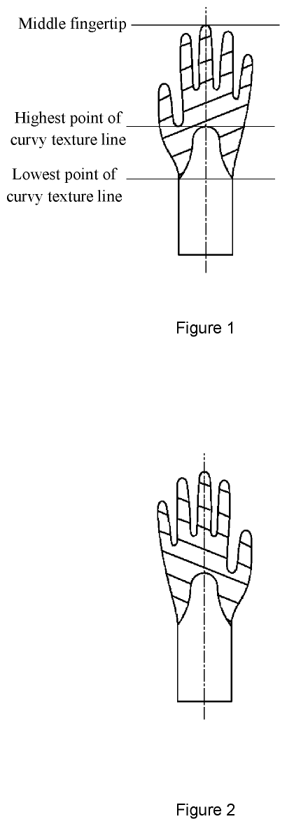

Referring to the accompanying drawings, FIG. 1 shows a front view of a glove with curvy palm texture. The textured surface area is represented by a hatched area while the untextured surface area is represented by a white area. As seen in the figure, the textured surface covers from the top of the fingertips to the palm area excluding the curvy area in between the highest point of curvy texture line to the lowest point of curvy texture line.

FIG. 2 shows a rear view of a glove with curvy palm texture wherein the design of textured surface area on the rear is similar to the design of textured surface area on the front. In a non-limiting example, the glove with curvy palm texture may be ambidextrous wherein it can be used for both hands. Alternatively, the glove with curvy palm texture may be hand specific wherein each glove is designed for either the right or the left hand.

Conceivably, the glove with curvy palm texture comes in four standard sizes: small, S, medium, M, large, L and extra-large, XL. However, there may be more variations of sizes. The curvy texture line on the examination glove can be located in between the palm and the wrist area wherein the minimum vertical distance between the highest point of the curvy texture line and the middle finger tip is 120 mm for S and M size glove, 130 mm for L and XL size glove. The maximum vertical distance between the lowest point of the curvy texture line and the middle finger tip is 190 mm for S size glove, 200 mm for M size glove, 210 mm for L size glove and 220 mm for XL size glove.

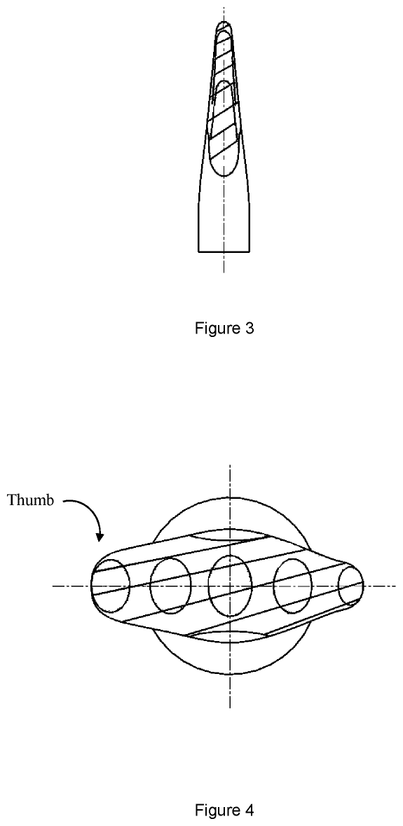

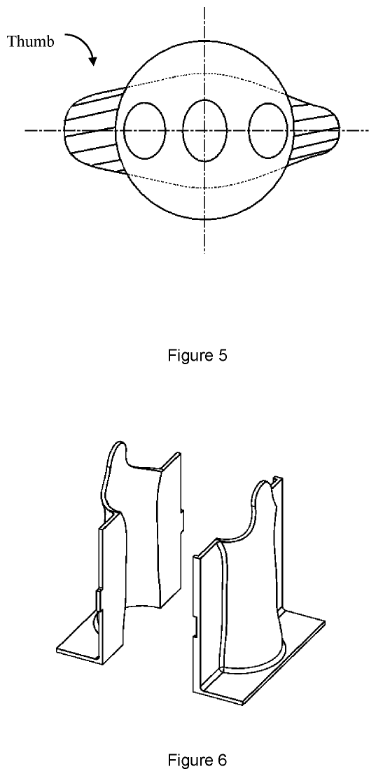

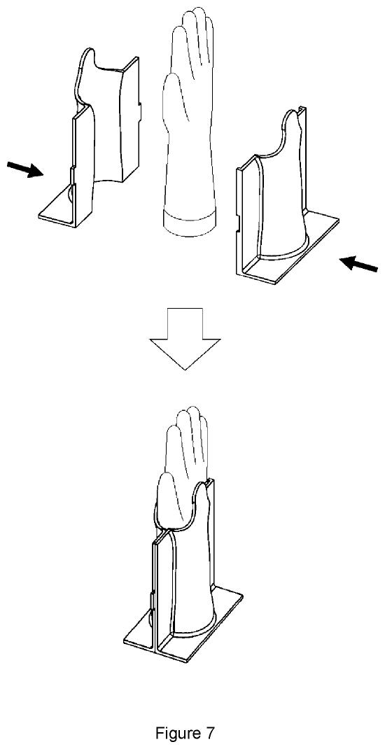

FIG. 3 is an illustrative figure of a side view of a glove with curvy palm texture (from thumb finger). The hatched areas represent the textured surface area wherein the textured surface area can be seen to include areas from below the thumb up to the top of the thumb. FIG. 4 is an illustrative figure of a top view of a glove with curvy palm texture wherein the top of each finger is textured and the textured surface area can be seen to surround the glove from all ends except the palm area and opposite of the palm area. FIG. 5 is an illustrative figure of a bottom view of a glove with curvy palm texture wherein it can be seen that the bottom of the thumb finger and little finger are textured. FIG. 6 is an illustrative figure of a right half cover and a left half cover of a pair of stencil covers. FIG. 7 is an illustrative figure of an assembly of a hand-shaped ceramic greenware to a pair of stencil covers.

### EXAMPLE 1

### Method of Manufacturing Curvy Palm Textured Glove Using Sandblasting

a) Preparing a hand-shaped ceramic greenware by slip casting, followed by drying and sponging after demoulding from slip casting.
b) Scanning the hand-shaped ceramic greenware thoroughly using short range 3D scanning wherein the digital 3D hand-shaped greenware model is generated and saved.
c) Importing the digital 3D hand-shaped greenware model into software like SolidWorks wherein the digital 3D hand-shaped greenware model serves as a reference during the 3D modelling of a pair of stencil covers for the hand-shaped ceramic greenware.
d) Modelling the stencil covers using SolidWorks wherein the modelling techniques involve surface modelling, freeform modelling and solid modelling. The stencil covers are modelled into two parts, a left half cover and a right half cover wherein they can be assembled and disassembled. When the left half cover is assembled to the right half cover, there is a cavity in between the assembly which allows the 3D hand-shaped greenware model to fit in between the covers. The stencil covers comprise a curvy texture line in between the palm and the wrist area wherein the curvy texture line is in a form of smooth line, step line, irregular line, geometrical line or a combination of at least two types of line as mentioned.
e) Printing the stencil covers using thermoplastics. Placing the 3D printed stencil covers in a sandblasting chamber by fixing the left half cover or the right half cover to a fixture on a turntable of the sandblasting chamber. A hand-shaped ceramic greenware is fitted onto the fixed half cover on the turntable. The unfixed half cover is then fitted onto the opposite side of the hand-shaped ceramic greenware to fully cover the hand-shaped ceramic greenware prior to sandblasting procedure.
f) Sandblasting the hand-shaped ceramic greenware that is covered by 3D printed stencil covers in the sandblasting chamber, using ceramic beads to create curvy palm texture on the hand-shaped ceramic greenware. The size of the ceramic beads ranges from 0.2-1.5 mm in diameter and the sandblasting pressure ranges from 0.1-0.5 bars.
g) Firing the hand-shaped ceramic greenware with curvy palm texture in a kiln at a temperature ranging from 1000° C. to 1500° C. and up to 12 hours.
h) Dipping the hand-shaped ceramic former with curvy palm texture in nitrile rubber latex to produce glove with curvy palm texture.

### EXAMPLE 2

### Method of Manufacturing Curvy Palm Textured Glove by Depositing Ceramic

a) Preparing a hand-shaped ceramic greenware by slip casting, followed by drying and sponging after demoulding from slip casting. Alternatively, other type of casting methods may be used.
b) Scanning the hand-shaped ceramic greenware thoroughly using short range 3D scanning wherein the digital 3D hand-shaped greenware model is generated and saved.
c) Importing the digital 3D hand-shaped greenware model into software like SolidWorks wherein the digital 3D hand-shaped greenware model serves as a reference during the 3D modelling of a pair of stencil covers for the hand-shaped ceramic greenware.
d) Modelling the stencil covers using SolidWorks wherein the modelling techniques involve surface modelling, freeform modelling and solid modelling. The stencil covers are modelled into two parts, a left half cover and a right half cover wherein they can be assembled and disassembled. When the left half cover is assembled to the right half cover, there is a cavity in between the assembly which allows the 3D hand-shaped greenware model to fit in between the covers. The stencil covers comprise a curvy texture line in between the palm and the wrist area wherein the curvy texture line is in a form of smooth line, step line, irregular line, geometrical line or a combination of at least two types of line as mentioned.
e) Printing the stencil covers using thermoplastics.
f) Depositing ceramic slip on the hand-shaped ceramic greenware to create curvy palm texture. The hand-shaped ceramic greenware is first placed in the designated cavity in between the left half cover and the right half cover of the 3D printed stencil covers. A ceramic slip is prepared by mixing 10-50% clay, 10-50% binder and 10-50% filler with water and then deposited on the hand-shaped ceramic greenware by spraying.
g) Firing the hand-shaped ceramic greenware with curvy palm texture in a kiln at a temperature ranging from 1000° C. to 1500° C. and up to 12 hours.
h) Dipping the hand-shaped ceramic former with curvy palm texture in nitrile rubber latex to produce glove with curvy palm texture.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises”, “comprising”, “including” and “having” are inclusive and therefore specify the presence of stated features, integers, steps, operations, elements and/or components, but do not preclude the presence or addition of one or more other features, integers, steps, operations, elements, components and/or groups therefrom.

The method steps, processes and operations described herein are not to be construed as necessarily requiring their performance in the particular order discussed or illustrated, unless specifically identified as an order of performance. It is also to be understood that additional or alternative steps may be employed. The use of the expression “at least” or “at least one” suggests the use of one or more elements, as the use may be in one of the embodiments to achieve one or more of the desired objects or results.

1. A method of manufacturing a textured former, the method comprises:
preparing a hand-shaped ceramic greenware;
scanning the hand-shaped ceramic greenware to generate a digital 3D hand-shaped greenware model;
modelling a pair of stencil covers with curvy texture line based on the digital 3D hand-shaped greenware model;
printing the stencil covers;
creating a curvy palm texture on the hand-shaped ceramic greenware with the aid of the 3D printed stencil covers; and
firing the hand-shaped ceramic greenware with curvy palm texture in a kiln.

2. The method of claim 1, wherein the hand-shaped ceramic greenware is prepared by slip casting, followed by demoulding, drying and sponging.

3. The method of claim 1, wherein the digital 3D hand-shaped greenware model is generated by scanning the hand-shaped ceramic greenware using techniques such as short range 3D scanning, medium and long range 3D scanning, laser based 3D scanning and projected or structured light 3D scanning.

4. The method of claim 1, wherein the stencil covers are modelled into two parts using modelling techniques such as surface modelling, freeform modelling and solid modelling, wherein the two parts, a left half cover and a right half cover can be assembled and disassembled.

5. The method of claim 4, wherein the assembled left half cover and right half cover of the stencil covers comprise a cavity wherein the hand-shaped ceramic greenware is placed in the cavity in between the stencil covers.

6. The method of claim 1, wherein the curvy palm texture is created by sandblasting the hand-shaped ceramic greenware that is covered by the stencil covers.

7. The method of claim 6, wherein the size of ceramic beads used for sandblasting ranges from 0.2-1.5 mm in diameter.

8. The method of claim 6, wherein the sandblasting pressure ranges from 0.1-0.5 bars.

9. The method of claim 1, wherein the curvy palm texture is created by depositing ceramic slip on the hand-shaped ceramic greenware that is covered by the stencil covers.

10. The method of claim 9, wherein the ceramic slip is deposited on the hand-shaped ceramic greenware by spraying or any other methods such as dipping.

11. The method of claim 9, wherein the ceramic slip is prepared by mixing 10-50% clay, 10-50% binder, 10-50% filler and water.

12. The method of claim 1, wherein hand-shaped ceramic greenware with curvy palm texture is fired in a kiln at a temperature ranging from 1000° C. to 1500° C.

13. he method of claim 1, wherein hand-shaped ceramic greenware with curvy palm texture is fired in a kiln for up to 12 hours.

14. A method of producing glove with curvy palm texture by dipping the hand-shaped ceramic former with curvy palm texture in an aqueous colloidal dispersion.

15. A former with curvy palm texture produced according to claim 1.

16. A glove with curvy palm texture produced according to claim 1.

17. The glove with curvy palm texture according to claim 16, wherein the glove with curvy palm texture are in four standard sizes: small, S, medium, M, large, L and extra-large, XL wherein;
the curvy texture line on the examination glove is located in between the palm and the wrist area wherein the minimum vertical distance between the highest point of the curvy texture line and the middle finger tip is 120 mm for S and M size glove, 130 mm for L and XL size glove; and
the maximum vertical distance between the lowest point of the curvy texture line and the middle finger tip is 190 mm for S size glove, 200 mm for M size glove, 210 mm for L size glove and 220 mm for XL size glove.
